(19) United States
(12) Patent Application Publication
(10) Pub. No.: US 2021/0355607 A1
(43) Pub. Date: Nov. 18, 2021

(54) POLYESTER HOLLOW FIBER WITH EXCELLENT SOUND ABSORPTION

(71) Applicants: Hyundai Motor Company, Seoul (KR); Kia Motors Corporation, Seoul (KR); Toray Advanced Materials Korea Inc., Seoul (KR)

(72) Inventors: Ji Wan Kim, Hwaseong (KR); Jungwook Lee, Bucheon (KR); Seongje Kim, Seongnam (KR); Mi Jung Yun, Yongin (KR); Jae-Hyun Sim, Gumi (KR); Yonggu Jo, Gumi (KR)

(21) Appl. No.: 17/089,368

(22) Filed: Nov. 4, 2020

(30) Foreign Application Priority Data
May 12, 2020 (KR) 10-2020-0056712

(51) Int. Cl. D01D 5/24; D01F 6/62; D01F 6/84; D01F 1/00; D01D 5/088

(52) U.S. Cl. CPC D01D 5/24; D01F 6/62; D01F 6/84; B60R 13/0815; D01D 5/088; D10B 2505/12; D10B 2331/04; D01F 1/00

(57) ABSTRACT

Disclosed are a polyester hollow fiber with excellent sound absorption and a method of manufacturing the same. The polyester hollow fiber may have a hollow ratio of about 27% to 35% compared to the cross-sectional area, and the value of the following equation (1) may be about 1.5 or greater, and the hollow in the cross-section preferably may be a three-lobed type and preferably may correspond to the following equation (1).

$$\frac{P}{\sqrt{4 Π A}} \qquad ( 1 )$$

In the above equation (1), A is the cross-sectional area (μm²) of the fiber, and P is the length (μm) around the cross-section of the fiber.

### CROSS-REFERENCE TO RELATED APPLICATION

This application is based on and claims priority under 35 U.S.C. § 119 to Korean Patent Application No. 10-2020-0056712, filed on May 12, 2020 in the Korean Intellectual Property Office, the disclosure of which is incorporated herein by reference.

### TECHNICAL FIELD

The present invention relates to a polyester hollow fiber with excellent sound absorption.

### BACKGROUND

In general, noise introduced into a vehicle can be divided into noise generated by the engine and introduced through the vehicle body and noise generated when the tire contacts the road surface and introduced through the vehicle body. Such noise can be avoided by improving sound absorption and improving sound insulation performance. Sound absorption means that generated sound energy is converted into heat energy and attenuated as it is transmitted through the inner path of the material and sound insulation is that the sound energy generated is reflected by the shield and blocked.

These sound absorbing and insulating materials are interior and exterior materials of vehicle, and have been widely used by attaching to a vehicle body or attaching to parts of vehicle. Typical materials used include glass fiber, urethane foam, miscellaneous felt, and general polyethylene terephthalate (PET) fiber. However, as regulations in each country on eco-friendliness and recyclability are gradually strengthening, the use of fiber sound-absorbing materials based on thermoplastic resins such as polyethylene terephthalate or polypropylene (PP) is increasing. In addition, in order to reduce carbon dioxide, the fuel economy regulation of vehicles is gradually getting deeper, and since the improvement of fuel efficiency can be achieved through weight reduction of parts, it is necessary to develop a light absorbing material with improved performance.

Fiber aggregates (e.g., non-woven fabrics) used as sound-absorbing materials for vehicle convert sound energy into heat energy by vibrating attenuation based on the viscous resistance of air and the viscoelastic properties of the fibers that make up the fiber aggregate and the aggregate and finally reduce the noise. The sound-absorbing and sound-insulating performance of the fiber-based sound-absorbing material may be influenced by the thickness of the fibers constituting the fiber aggregate, the surface density of the fiber aggregate, and the thickness of the fiber aggregate.

Conventionally, fibers with a hollow ratio of about 10% to 24% and a cross-section hollow shape of two-lobed type have been used as sound-absorbing material. However, in the case of the existing two-lobed type hollow fiber, it has an oval-shaped hollow, so it is vulnerable to compression or external force during the processing process. For this reason, the co two-lobed type hollow fiber has a problem that the hollow ratio and bulkiness in the fiber state are reduced in the final product as the hollow is crushed.

### SUMMARY

In preferred aspects, provided are a polyester hollow fiber with excellent sound absorption that may maintain a uniform density after processing and excellent fiber uniformity by securing a stable hollow ratio and a method of manufacturing the same.

A term “hollow fiber” as used herein refers to a fiber that may have a structure that has an inner empty space, such as channel or hole, surrounded by a fiber material or other components such as filler surrounding the inner space. Preferred hollow fiber may include a core as a form of hole or channel without a filler material or other components.

In an aspect, provided is a polyester hollow fiber with excellent sound absorption. The polyester hollow fiber may have a hollow ratio of the polyester hollow fiber of about 27% to 35% compared to a cross-sectional area of the polyester hollow fiber, and a value of equation (1) of about 1.5 or greater, and a hollow in the cross-section of the polyester hollow fiber is a three-lobed type.

$$\frac{P}{\sqrt{4 Π A}} \qquad ( 1 )$$

In the equation (1), A is the cross-sectional area (μm²) of the fiber, and P is the length (μm) around the cross-section of the fiber.

The recovery ratio of the polyester hollow fiber represented by the following equation (2) may be about 95% or greater:

(C−B)/(A−B)*100 (2)

The specific volume of the polyester hollow fiber represented by the following equation (3) may be about 90 cm³/g or greater.

(10*10*A)/10. (3)

The compression ratio represented by the following equation (4) may be 45% or less.

(A−B)/A*100. (4)

In the above equation (2), (3) and (4), A, B, and C may be measured after i) opening the polyester hollow fiber, ii) stacking 10 g of cubes on an acrylic container of 10 cm×10 cm in the form of a web, and then iii) preparing a sample by leaving it for 24 hours. A may be an average value of the heights of the four corners in the state of removing 500 g load and applying 50 g primary load after a process of applying 50 g primary load to the sample, additionally applying 500 g load, removing the loads after 10 seconds and re-applying the loads after 10 seconds is repeated three times. B may be an average value of the heights of the four corners after 60 seconds in the state of measuring A and then additionally applying a load of 1000 g. C may be an average value of the heights of the four corners after 180 seconds in the state of measuring B and then removing the load of 1000 g.

The hollow in the cross-section of the polyester hollow fiber may be triangular and the largest angle of the triangle may be an acute angle.

The fineness of the polyester hollow fiber may be about 15 denier to 20 denier.

The polyester hollow fiber may further include: an amount of about 1 mol % or less of isophthalic acid.

The polyester hollow fiber may include recycled polyester chips or virgin chips.

In an aspect, provided is a method of manufacturing a polyester hollow fiber. The method may include preparing a polyester chip; preparing a polyester hollow fiber by melt spinning the polyester chip; and winding the polyester hollow fiber. Preferably, in the melt spinning the polyester chip, a distance from a surface of the spinneret to a cooling initiation field may be about 40 mm or less, the wind speed of the cooling air is 80 m/min to 100 m/min, the exhaust is 50% to 100%.

The manufacturing the polyester chip may include: reacting an acidic component and a diol component with virgin chips through esterification and polymerization, or manufacturing recycled polyester chips including post-consumer recycled raw materials and pre-consumer recycled raw materials.

The acidic component may include one or more selected from the group consisting of dimethyl terephthalate, dimethyl isophthalate, terephthalic acid, and isophthalic acid.

The diol component may include one or more selected from the group consisting of ethylene glycol, 1,4-butanediol, and polytetramethylene glycol.

Further provided is a fiber aggregate with excellent sound absorption that may include the polyester hollow fiber as described herein.

Also provided is a vehicle including the polyester hollow fiber as described herein.

Other aspects of the invention are disclosed infra.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 shows an exemplary shape of an exemplary discharge slit according to an exemplary embodiment of a present invention.

FIG. 2A is a SEM photograph of a fiber aggregate of fibers having a two-lobed type hollow shape in a conventional cross-section, and FIG. 2B is a SEM photograph of an exemplary fiber aggregate according to an exemplary embodiment of the present invention.

FIG. 3 is a graph illustrating measured sound absorption coefficients of the nonwoven fabrics of Inventive Example 2 and Comparative Example 2.

### DETAILED DESCRIPTION

Hereinafter, preferred embodiments of the present invention will be described. However, the embodiments of the present invention may be modified into various other forms, and the technical idea of the present invention is not limited to the embodiments described below. Further, the embodiments of the present invention are provided to more fully explain the present invention to those skilled in the art.

The terms used in the present application are used only to illustrate specific examples. Thus, for example, the expression of the singular includes plural expressions unless the context clearly dictates otherwise. In addition, the terms “include” or “have,” and the like used in the present application are used to specifically denote the presence of stated features, steps, functions, elements, or combinations thereof and the like, and are not used to preparatorily preclude the presence of elements, steps, functions, components, or combinations thereof.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Unless defined otherwise, all terms used herein should be interpreted to have the same meaning as commonly understood by one of ordinary skill in the art to which this invention belongs. Thus, unless explicitly defined herein, certain terms should not be construed in an overly ideal or formal sense.

A polyester hollow fiber with excellent sound absorption may have a hollow ratio of the polyester hollow fiber of about 27% to 35% compared to a cross-sectional area of the polyester hollow fiber, and a value of the following equation (1) may be of about 1.5 or greater, and the hollow in the cross-section may correspond to the following equation (1):

$$\frac{P}{\sqrt{4 Π A}} \qquad ( 1 )$$

In the above equation (1), A is the cross-sectional area (μm²) of the fiber, and P is the length (μm) around the cross-section of the fiber. Here, the cross-sectional area A of the fiber refers to the area of the entire cross-section of the fiber minus the hollow.

In another aspect, the polyester hollow fiber may be a three-lobed type.

The hollow fiber material may include polyester material in consideration of eco-friendliness, recyclability, and viscoelastic properties that convert sound energy into thermal energy. For example, the polyester may include one or more of polyethylene terephthalate (PET), polybutylene terephthalate (PBT), and polytrimethylene terephthalate (PTT).

The polyester hollow fiber with excellent sound absorption according to the present invention may have a hollow ratio of about 27% to 35% compared to the cross-sectional area. In order to convert sound energy into thermal energy, it is important to maximize the friction area. To this end, in the present invention, the inner surface area may be increased together with the outer surface area of the fiber. The inner surface area means the surface area of the fiber in contact with the hollow in the fiber. For considering improvement of the sound absorption property, it is preferable that the hollow ratio of the polyester hollow fiber may be about 27% or greater compared to the cross-sectional area. However, when the hollow ratio is too high, there is a possibility that the hollow may be crushed during processing because it is vulnerable to external force. As such, the hollow ratio of the polyester hollow fiber may be preferably about 35% or less compared to the cross-sectional area.

The polyester hollow fiber with excellent sound absorption may satisfy a value of about 1.5 or greater in equation (1) below.

$$\frac{P}{\sqrt{4 Π A}} \qquad ( 1 )$$

In the above equation (1), A is the cross-sectional area (μm²) of the fiber, and P is the length (μm) around the cross-section of the fiber. Here, the cross-sectional area A of the fiber refers to the area of the entire cross-section of the fiber minus the hollow.

Equation (1) is related to the non-circularity of the cross section. As the value of equation (1) increases, the fiber surface area is wider, and the sound absorption coefficient and transmission loss can be improved. When the value of equation (1) is less than about 1.5, the fiber surface area may be small, and a large amount of fiber is required to effectively secure sound-absorbing performance, and thus a lightweight design is impossible. Accordingly, a polyester hollow fiber with excellent sound absorption may have a value of about 1.5 or greater in equation (1).

The polyester hollow fiber with excellent sound absorption may have a three-lobed type (trilobal) hollow within a cross-section. The three-lobed type of hollow in the cross-section means that the hollow in the cross-section is a structure composed of three lobes each having a tip. Examples of the three-lobed type include Y-shaped and triangular, and the curvature in the concave portion between each lobe may be appropriately adjusted in consideration of sound absorption.

The sound waves transmitted into the hollow may be diffusely reflected, causing mutual interference of the sound waves to be extinguished. As the diffuse reflectance increases, sound absorption improves. Considering the diffuse reflectance, the hollow may be more preferably a triangle. For example, the triangle may be the most stable against external forces, and while securing a large surface area, so it is advantageous in diffuse reflection of sound and can secure excellent sound absorption. In consideration of the above characteristics, more preferably, the largest angle of the triangle may be an acute angle.

The polyester hollow fiber with excellent sound absorption may have a recovery ratio represented by the following equation (2) of about 95% or greater.

(C−B)/(A−B)*100 (2)

The recovery ratio refers to the property that when an external force is applied, it is deformed in the direction in which the external force is applied, and when the external force is removed, it returns to its original shape. The greater the value of the recovery ratio according to equation (2), the more flexible the fiber aggregate becomes, and sufficiently secure the viscoelasticity of the fiber. Accordingly, it is possible to sufficiently secure sound absorption by converting sound energy into thermal energy by a vibration attenuation phenomenon due to viscoelastic properties. Also, the greater the recovery ratio, the greater the stability against the external force of the hollow.

The polyester hollow fiber with excellent sound absorption may have a specific volume represented by the following equation (3) of about 90 cm³/g or more.

(10*10*A)/10 (3)

The specific volume is the reciprocal of the density as the volume to the unit mass of an object. The greater the specific volume according to equation (3), the more advantageous the fiber aggregate is lightweight.

The polyester hollow fiber with excellent sound absorption may have a compression ratio represented by the following equation (4) of about 45% or less.

(A−B)/A*100 (4)

The compression ratio refers to the degree to which the volume of a material changes due to compression. The greater the compression ratio, the more the hollow is crushed by the external force applied to the fiber. That is, the higher the compression ratio, the lower the stability against the external force of the hollow.

In the above equations (2), (3), and (4), A, B, and C are measured in the following way: after opening the polyester hollow fiber, stacking 10 g of cubes on an acrylic container of 10 cm×10 cm in the form of a web, and then preparing a sample by leaving it for 24 hours. A is an average value of the heights of the four corners in the state of removing 500 g load and applying 50 g primary load after a process of applying 50 g primary load to the sample, additionally applying 500 g load, removing the loads after 10 seconds and re-applying the loads after 10 seconds is repeated three times. B is an average value of the heights of the four corners after 60 seconds in the state of measuring A and then additionally applying a load of 1000 g. C is an average value of the heights of the four corners after 180 seconds in the state of measuring B and then removing the load of 1000 g.

Moreover, a manufacturing method of a polyester hollow fiber with excellent sound absorption will be described.

The manufacturing method of a polyester hollow fiber may include manufacturing a polyester chip, preparing a polyester hollow fiber by melt spinning the polyester chip and winding the polyester hollow fiber.

The manufacturing the polyester chip may include reacting an acidic component and a diol component into virgin chips through esterification and polymerization, or manufacturing recycled polyester chips using post-consumer recycled raw materials and pre-consumer recycled raw materials.

The acidic component may be, for example, dimethyl terephthalate (DMT), dimethyl isophthalate (DMI), or terephthalic acid (TPA) and isophthalic acid (IPA). Dimethyl terephthalate (DMT) and terephthalic acid (TPA) react with the diol component to form a crystal region, and Dimethyl isophthalate (DMI) and isophthalic acid (IPA) react with the diol component to form an amorphous region to impart low melting point properties and elasticity to the material, but the strength of the fiber decreases.

The diol component may include, for example, ethylene glycol (EG), 1,4-butanediol (1,4-BD), and polytetramethylene glycol (PTMG). 1,4-butanediol reacts with an acidic component to form a crystal region, and polytetramethylene glycol reacts with an acidic component to form an amorphous region, thereby imparting low melting point properties and elasticity. The acidic component and diol component can be appropriately selected and the amount can be adjusted in consideration of the low melting point characteristics and elasticity.

In addition, one or more of isophthalic acid and neopentyl glycol may be added to the prepared polyester as a high shrinkage modifier. Isophthalic acid may reduce the volume of the crystal region of polyester, and may increase the shrinkage rate by increasing the volume of the amorphous region and reducing the crystal region by adding neopentyl glycol. In general, it can be divided into a two-phase structure divided into a crystal region and an amorphous region in terms of fiber formation. The crystal region may have the regular and orderly arrangement of polymer chains and may be functionally involved in the strength, elasticity, and heat resistance of the fiber. When isophthalic acid and neopentyl glycol are added, the volume of the amorphous region may increase and the volume of the crystal region may decrease, so that the strength of the fiber decreases, and the crimp property related to flexibility may be improved.

The preparing a polyester hollow fiber by melt spinning the polyester chip may be a key manufacturing step by controlling the hollow ratio, non-circularity, and shape of the hollow fiber.

The polyester chips may be first melted and then discharged through a spinneret. At this time, the spinning temperature may be about 270° C. to 275° C. The spinneret may be composed of an induction hole provided to allow molten polyester to flow in one direction, and a discharge hole through which the polyester passing through the induction hole is discharged. The discharge hole may include a discharge slit, and the design may be appropriately changed in consideration of the size and shape of the controlled hollow.

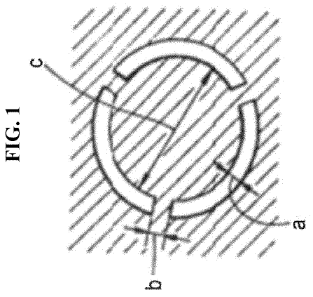

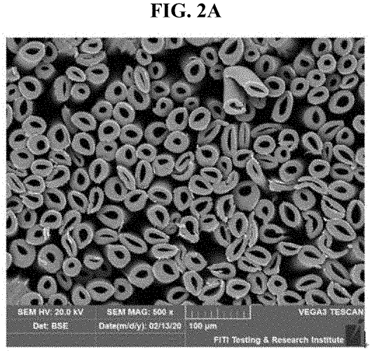

The discharge slit can be composed of three slits to make a three-lobed type hollow. FIG. 1 shows an exemplary shape of a discharge slit according to an example of a present invention. As shown in FIG. 1, by appropriately controlling the thickness a and spacing b of each discharge slit and the inner diameter c of the discharge hole, it can be manufactured into a three-lobed type hollow.

According to various exemplary embodiments of the present invention, it is possible to maximize the bulk characteristics and non-circularity of fibers such as specific volume, compression ratio, and recovery ratio by controlling the conditions for rapidly cooling and solidifying the polyester discharged from the spinneret in the shortest time possible. For example, the distance from a surface of the spinneret to a cooling initiation field can be controlled to about 40 mm or less. When the distance of the cooling initiation field is greater than about 40 mm, there is a concern that crimp may occur on the fiber after the spinning process. In addition, at this time, the wind speed of the cooling air may preferably be in the range of about 80 m/min to 100 m/min for maximizing non-circularity, and the exhaust may preferably be about 50% to 100% for maximizing non-circularity. The fibers solidified by rapid cooling can be drawn and then wound up.

The polyester hollow fiber can constitute a fiber aggregate with other compositions. In addition to the polyester hollow fiber, the composition contained in the fiber aggregate may further include a low melting point elastomer, a recycled regular yarn, and the like according to the desired physical properties. The fiber aggregate may be, for example, a nonwoven fabric, a woven fabric, a knitted fabric, a film, a spunbond fabric, a meltblown fabric, a staple web, and the like.

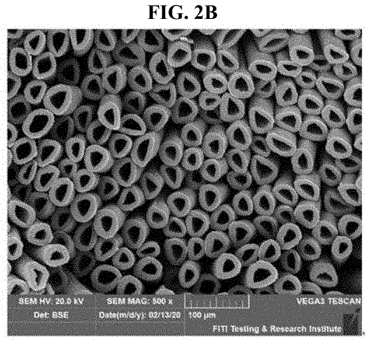

FIG. 2A is a SEM photograph of a fiber aggregate of fibers having a two-lobed type hollow shape in a conventional cross-section, and FIG. 2B is a SEM photograph of the fiber aggregate according to an exemplary embodiment of the present invention. Comparing FIGS. 2A and 2B, it can be seen that the conventional fiber has poor bulk properties due to the crushed hollow after processing, and the fiber according to an exemplary embodiment of the present invention maintains a hollow shape even after processing so that it is stable against external force.

Polyester hollow fiber and fiber aggregate according to various exemplary embodiments of the present invention can be used as a sound-absorbing material for vehicle that block the inflow of external noise into the vehicle interior, or can be used throughout trains, ships, aircraft, etc., and can be used in a variety of ways to improve noise blocking performance in electronic products that use motor parts.

Hereinafter, the present invention will be described in more detail through examples. However, it should be noted that the following examples are for illustrative and more detailed description of the present invention, and not for limiting the scope of the present invention. This is because the scope of the present invention is determined by the matters described in the claims and the matters reasonably inferred therefrom.

### EXAMPLE

### Preparation of Comparative Example 1

Polyester chips made of terephthalic acid and ethylene glycol as raw materials were melt-spinned using a spinneret having two discharge slits to produce a fiber having a two-lobed type hollow shape in a conventional cross-section. The distance of the cooling initiation field from the surface of the spinneret was 50 mm or more, the wind speed of the cooling air was 80 m/min or less, and the spinning temperature was 270° C. to 275° C. The prepared hollow fiber of Comparative Example 1 had a hollow ratio of 10% to 24%, and a non-circularity value of equation (1) was 1.0 to 1.2.

### Preparation of Inventive Example 1

Terephthalic acid and ethylene glycol were esterified to prepare polyethylene terephthalate, and then isophthalic acid was added as a high shrinkage modifier to prepare a polyester chip. Then, the polyester chips were melt-spinned using a spinneret having three discharge slits to produce a fiber having a three-lobed type hollow shape in a cross-section. The distance of the cooling initiation field from the surface of the spinneret was 40 mm or less, the wind speed of the cooling air was 80 m/min to 100 m/min, and the spinning temperature was 270 to 275° C. The prepared hollow fiber of Inventive Example 1 had a hollow ratio of 27% to 35%, and a non-circularity value of equation (1) was 1.5 or more.

In order to evaluate the bulk characteristics of Inventive Example 1 and Comparative Example 1, specific volume, compression ratio, and recovery ratio were measured. After opening the polyester hollow fiber of Inventive Example 1 and Comparative Example 1, stacking 10 g of cubes on an acrylic container of 10 cm×10 cm in the form of a web, and then preparing a sample by leaving it for 24 hours.

A: the average value of the heights of the four corners in the state of removing 500 g load and applying 50 g primary load after a process of applying 50 g primary load to the sample, additionally applying 500 g load, removing the loads after 10 seconds and re-applying the loads after 10 seconds is repeated three times.

B: the average value of the heights of the four corners after 60 seconds in the state of measuring A and then additionally applying a load of 1000 g.

C is the average value of the heights of the four corners after 180 seconds in the state of measuring B and then removing the load of 1000 g.

The specific volume, compression ratio, and recovery ratio were derived by the following equation.

specific volume(cm³/g)=(10*10*A)/10(Sample weight 10 g)

compression ratio (%)=(A−B)/A*100

recovery ratio (%)=(C−B)/(A−B)*100

The measured specific volume, compression ratio, and recovery ratio are shown in Table 1 below.

TABLE 1

| | Comparative | Inventive |
|---|---|---|
| | Example 1 | Example 1 |
| specific volume(cm³/g) | 85.0 | 95.1 |
| compression ratio(%) | 44.5 | 43.3 |
| recovery ratio(%) | 93.2 | 96.0 |

Referring to Table 1, it can be seen that the specific volume of Inventive Example 1 is higher than that of Comparative Example 1, so that it is more advantageous for weight reduction when configuring a fiber aggregate. In addition, it can be seen that the compression ratio of Inventive Example 1 is lower than that of Comparative Example 1, so that the stability against external force of the hollow is higher. In addition, it can be seen that sound absorption is more advantageous because the recovery ratio of Inventive Example 1 is higher than that of Comparative Example 1.

Inventive Example 2 and Comparative Example 2 in the form of non-woven fabrics were prepared by consisting of 40% by weight of hollow fibers of each of Inventive Example 1 and Comparative Example 1, 30% by weight of a low melting point elastomer, and 30% by weight of recycled regular yarn.

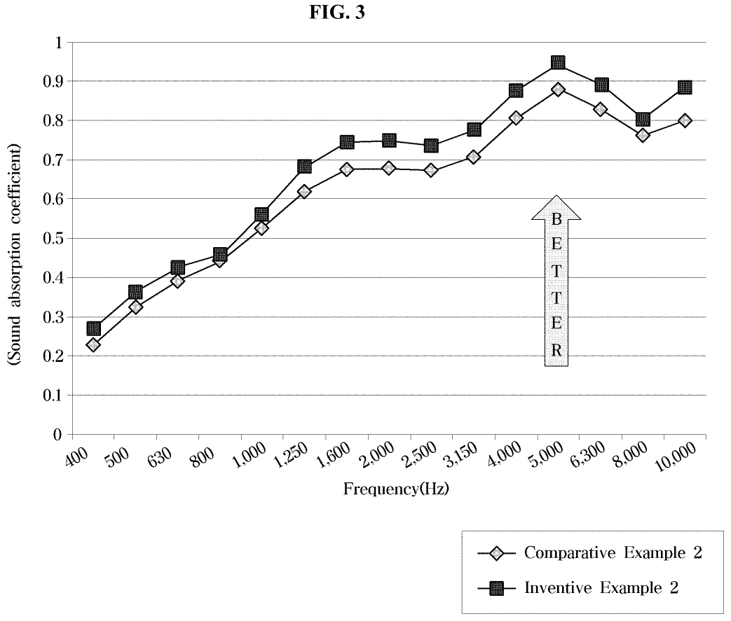

The sound absorption of the nonwoven fabrics of Inventive Example 2 and Comparative Example 2 was evaluated. Inventive Example 2 and Comparative Example 2 were prepared as specimens of 1 m×1.2 m, and then 15 sound sources from 400 Hz to 10000 Hz were input according to ISO 354 standards, and the sound absorption coefficient was measured for the reverberation. The results of the measured sound absorption are shown in Table 2 and FIG. 3 below.

TABLE 2

sound absorption coefficient

| frequency (Hz) | Comparative Example 2 | Inventive Example 2 |
|---|---|---|
| 400 | 0.228 | 0.27 |
| 500 | 0.325 | 0.364 |
| 630 | 0.392 | 0.425 |
| 800 | 0.444 | 0.459 |
| 1000 | 0.526 | 0.56 |
| 1250 | 0.619 | 0.685 |
| 1600 | 0.675 | 0.746 |
| 2000 | 0.68 | 0.749 |
| 2500 | 0.673 | 0.737 |
| 3150 | 0.707 | 0.776 |
| 4000 | 0.805 | 0.875 |
| 5000 | 0.879 | 0.947 |
| 6300 | 0.83 | 0.892 |
| 8000 | 0.763 | 0.804 |
| 10000 | 0.8 | 0.886 |
| Average | 0.623 | 0.678 |

Referring to Table 2 and FIG. 3, it can be seen that the sound absorption of Inventive Example 2 is better than that of Comparative Example 2 in the frequency range of 400 Hz to 10000 Hz. From this, it can be seen that the hollow fiber of Inventive Example 1 is more advantageous in sound absorption when composed of fiber aggregates than the hollow fiber of Comparative Example 1.

The embodiments disclosed with reference to the accompanying drawings and tables have been described above. It will be understood by those of ordinary skill in the art that various changes in form and details may be made therein without departing from the spirit and scope of the present invention as defined by the following claims. The disclosed embodiments are illustrative and should not be construed as limiting.

According to various exemplary embodiment of the present invention, a stable hollow ratio can be secured by controlling the hollow shape of the fiber into a three-lobed type hollow. In addition, it is possible to provide a polyester hollow fiber with excellent sound absorption that may maintain a uniform density after processing and excellent fiber uniformity by securing a stable hollow ratio.

What is claimed is:

1. A polyester hollow fiber having a hollow ratio of about 27% to 35% compared to a cross-sectional area of the polyester hollow fiber, and a value of the following equation (1) is about 1.5 or greater, and a hollow in the cross-section of the polyester hollow fiber corresponds to the following equation (1):
$$\frac{P}{\sqrt{4 Π A}} \qquad ( 1 )$$
wherein in the equation (1), A is the cross-sectional area (μm²) of the fiber, and P is the length (μm) around the cross-section of the fiber.

2. The polyester hollow fiber according to claim 1, wherein a recovery ratio of the polyester hollow fiber represented by the following equation (2) is about 95% or greater:
(C−B)/(A−B)*100 (2)
wherein in the equation (2), A, B, and C are measured after i) opening the polyester hollow fiber, ii) stacking 10 g of cubes on an acrylic container of 10 cm×10 cm in the form of a web, and iii) then preparing a sample by leaving it for 24 hours;
A is an average value of the heights of the four corners in the state of removing 500 g load and applying 50 g primary load after a process of applying 50 g primary load to the sample, additionally applying 500 g load, removing the loads after 10 seconds and re-applying the loads after 10 seconds is repeated three times;
B is an average value of the heights of the four corners after 60 seconds in the state of measuring A and then additionally applying a load of 1000 g;
C is an average value of the heights of the four corners after 180 seconds in the state of measuring B and then removing the load of 1000 g.

3. The polyester hollow fiber according to claim 2, wherein a specific volume of the polyester hollow fiber represented by the following equation (3) is about 90 cm³/g or greater:
(10*10*A)/10. (3)

4. The polyester hollow fiber according to claim 3, wherein a compression ratio of the polyester hollow fiber represented by the following equation (4) is about 45% or less:
(A−B)/A*100. (4)

5. The polyester hollow fiber according to claim 1, wherein the hollow in the cross-section of the polyester hollow fiber is triangular.

6. The polyester hollow fiber according to claim 5, wherein the largest angle of the triangle is an acute angle.

7. The polyester hollow fiber according to claim 1, wherein a fineness of the polyester hollow fiber is about 15 denier to 20 denier.

8. The polyester hollow fiber according to claim 1, further comprising an amount of about 1 mol % or less of isophthalic acid.

9. The polyester hollow fiber according to claim 1, comprising recycled polyester chips or virgin chips.

10. A manufacturing method of a polyester hollow fiber, comprising:
preparing a polyester chip;
preparing a polyester hollow fiber by melt spinning the polyester chip; and
winding the polyester hollow fiber, and
wherein in the melt spinning the polyester chip, a distance from a surface of the spinneret to a cooling initiation field is about 40 mm or less, a wind speed of the cooling air is about 80 m/min to 100 m/min, and an exhaust is about 50% to 100%.

11. The manufacturing method according to claim 10, wherein the preparing the polyester chip comprises:
reacting an acidic component and a diol component with virgin chips through esterification and polymerization, or manufacturing recycled polyester chips using post-consumer recycled raw materials and pre-consumer recycled raw materials.

12. The manufacturing method according to claim 11, wherein the acidic component comprises one or more of dimethyl terephthalate, dimethyl isophthalate, terephthalic acid, and isophthalic acid.

13. The manufacturing method according to claim 11, wherein the diol component comprises one or more of ethylene glycol, 1,4-butanediol, and polytetramethylene glycol.

14. A fiber aggregate with excellent sound absorption, comprising a polyester hollow fiber according to claim 1.

15. A vehicle comprising a polyester hollow fiber according to claim 1.
